(19) United States
(12) Patent Application Publication
(10) Pub. No.: US 2007/0228615 A1
(43) Pub. Date: Oct. 4, 2007

(54) High clarity formed articles of polypropyline

(75) Inventors: Gary T. Brooks, Naperville, IL (US); John D. Girardot, Aurora, IL (US); Michael J. Rutledge, Naperville, IL (US)

Correspondence Address: INEOS USA LLC, 3030 Warrenville Road, S/650, Lisle, IL, 60532, US

(73) Assignee: Innovene USA, Chicago, IL (US)

(21) Appl. No.: 11/365,403

(22) Filed: Mar. 1, 2006

Related U.S. Application Data
(62) Division of application No. 10/832,007, filed on Apr. 26, 2004.
(60) Provisional application No. 60/466,852, filed on Apr. 30, 2003.

(51) Int. Cl. B29C 35/08

(52) U.S. Cl. 264/403

(57) ABSTRACT

High clarity polypropylene articles comprising an infrared absorbing agent such as carbon black in the amount of about 0.1 to 500 parts per million by weight of polymer. Containers such as bottles can be made at substantially improved processing rates by injection stretch blow molding.

### BACKGROUND OF THE INVENTION

Thermoplastics such as polyesters and polyolefins are now commonly used in the packaging industry because thermoplastic materials allow flexibility in the design and fabrication of formed articles. Thermoplastics are used in food packaging application such as bottles, jars and similar containers to store food, beverages and other products. Polyesters such as polyethylene terephthalate (PET) are commonly used for carbonated soft drink bottles and similar articles where high clarity and good gas barrier properties are desired. Polyolefins have also been used in formed articles. Polyethylene bottles are typically less clear (higher haze) and exhibit poorer barrier properties than PET bottles. Polyethylene is commonly used for milk bottles. Bottles with good barrier properties can be made from polypropylene in combination with barrier materials such as ethylene vinyl alcohol (EVOH). Although these bottles have better clarity than polyethylene bottles, they are typically less clear than PET bottles. Polypropylene has found use in ketchup and syrup bottles.

Different engineering techniques are used with the different materials. PET bottles are typically made using a conventional two-step injection stretch blow molding process (ISBM). In the first step, resin is injection molded into a preform and cooled to ambient temperature. Next, the preform is reheated and softened by an infrared heat source. Immediately following reheating, the preform is stretched mechanically and blown into the bottle. The two steps can be separated in time so that preforms can be made and stored for later reheat and stretch blow molding into finished products. Polyethylene milk bottles and polypropylene ketchup and syrup bottles are typically made by extrusion blow molding (EBM) processes. In EBM a molten hollow parison is continuously extruded. The molten parison is then clamped at one end in a mold. A blow pin is inserted at the opposite end and air is blown through to create a bottle. The bottle is cooled and ejected. Polypropylene has not been widely adapted for use in ISBM because, among other things, the heat up of polypropylene preforms by infrared has been too slow, resulting in up to 30% less throughput in comparison to PET. This reduced throughput results in unfavorable process economics.

PET currently enjoys broader use in high clarity packaging relative to polypropylene due to its higher clarity and lower process costs. However, packaging costs, e.g., the cost of bottles, are a significant part of the cost for food and beverage products. Accordingly, the packaging industry continues to seek improvements in both product properties and process economics and there is a need for packaging products and manufacturing processes with improved properties and improved process economics. Polypropylene could enjoy broader use in the packaging industry if methods were found to improve the clarity of polypropylene and/or improve the cost of processing polypropylene into articles.

Carbon black is widely used as a colorant to make polypropylene and other thermoplastic articles dark or opaque. Carbon black has also been added to thermoplastics to improve end product and/or process characteristics in formed articles including packaging. U.S. Pat. No. 3,247,159 to Pendleton, et al. discloses the use of small amounts of carbon black to polyethylenes of certain densities to produce films with good optical properties. U.S. Pat. No. 4,476,272 to Pengilly discloses the addition of very small amounts of carbon black to polyesters resulting in compositions with improved infrared absorption and improved infrared heat up rates in processing preforms into finished products bottles. U.S. Pat. No. 5,604,289 to Delimoy discloses the use of very small amounts of carbon black to polypropylenes to produce compositions with improved heatup rates. The patent discloses that good mechanical properties and increased productivity result in the manufacture of reinforced fiber bundles and polymer impregnated fabrics. The prior art does not disclose that addition of small amounts of carbon black to polypropylene would allow polypropylene to be used to make articles by ISBM with both improved processing economics and high clarity in comparison to PET.

### SUMMARY OF THE INVENTION

Surprisingly, it has been found that the addition of very small amounts of infrared absorbing agents such as carbon black to propylene polymers enables production of articles such as bottles to be injection stretch blow molded with both exceptional clarity and mechanical properties to be processed at substantially improved rates. ISBM polypropylene bottles of the invention are characterized by very high clarity or low haze and particularly by very low ratios of haze to polymer thickness. For example, polypropylene bottles with side walls about 0.5 mm thick and made without an infrared absorber possess haze to thickness ratios of about 40%/mm and were not easily made by ISBM. Comparable polypropylene bottles of the invention possess haze to thickness ratios of less than about 14%/mm. Additionally, the polypropylene bottles containing small amounts of carbon black can be produced by ISBM at rates of about fifty percent greater than bottles without carbon black.

Accordingly, it is an object of the invention to provide high clarity articles comprising one or more layers of polypropylene and an infrared absorbing agent present in an amount of about 0.1 to 500 parts per million by weight of polymer. It is another object of the invention to provide high clarity articles comprising polypropylene and infrared absorbing agents present in the amount of about 1 to 50 ppm by weight of polymer. Still another object of the invention is an injection stretch blow molded bottle comprising carbon black as the infrared absorbing agent. It is still another object of the invention to provide a high clarity polypropylene bottle with a ratio of haze to polymer thickness of about 25%/mm or less. Still another object of the invention is to provide a high clarity article comprising one or more layers of polypropylene and a layer of barrier material.

It is still another object of the invention to provide a method for making articles comprising one or more layers of polypropylene with high clarity and excellent mechanical properties at high rates of production comprising the steps of heating a preform of the article with infrared radiation wherein the preform comprises polypropylene and an infrared absorbing agent present in the amount of about 0.1 to 500 parts per million by weight of polymer; mechanically stretching and blow molding the preform into the article. Another object of the invention is a method for making a high clarity polypropylene bottle comprising carbon black in the range of about 1 to 50 ppm by weight of polymer and having a ratio of haze to polymer thickness of about 25%/mm or less. Still another object of the invention is to provide a method for making high clarity articles comprising one or more layers of polypropylene and a layer of barrier material.

### DETAILED DESCRIPTION OF THE INVENTION

Articles can be made in various ways from various thermoplastics. It can be highly desirable that bottles and other articles used for foods and beverages exhibit low haze and be very clear, and good barrier properties. It is also highly desirable that the thermoplastic materials possess good mechanical properties to enable high throughput in their manufacture to reduce production costs. Polypropylenes generally exhibit good mechanical properties for use in bottles and similar articles but have not been widely adopted for use in such because their manufacturing economics compare unfavorably to the manufacturing economics available for other thermoplastic materials such as PET. Polypropylenes can be combined with barrier materials such as EVOH to produce multi-layered articles with good barrier properties. This is described more fully in International Patent Publication No. WO 00/63085 by Pechiney Plastic Packaging, Inc., which is incorporated herein by reference.

Two-stage injection stretch blow molding is often used to make PET articles such as bottles. In two-stage ISBM, a preform of the article is injection molded, cooled to ambient temperature, reheated and then stretch blow molded into the final article. Infrared heating (e.g., an infrared oven) is commonly employed in the reheating step. ISBM has not been commonly used in the manufacture of polypropylene bottles because the infrared heating of polypropylene has been inefficient resulting in slow processing of the ISBM bottles. Surprisingly, however, it has been found that the addition of very small amounts of an infrared absorber such as carbon black can be added to polypropylene enabling substantially enhanced clarity of the article and manufacturing productivity in the two-stage ISBM process.

As used herein, polypropylene is understood to include any polymer and copolymer of propylene and any polypropylene can be used in the invention. Propylene polymer is typically understood to mean any polymer substantially made up of propylene monomer. Polypropylene copolymer is typically understood to mean any random or block copolymer of propylene substantially made up of propylene monomer and relatively small amounts of other alkenes, e.g., about 10% or less of ethylene, butene, pentene, hexene and the like as is known in the art. The amount of smaller alkenes is preferably less than about 5%. Polypropylene formulations already exhibiting good clarity and neutral hue are desirable starting materials. Polypropylene can be used in the form of a resin, powder, pellet or other conventional form.

The articles of the invention are understood to include single and multi-layered articles, including as bottles, comprising one or more layers of polypropylene and one or more other layers comprising, for example, a desirable barrier material such as EVOH. Further, multi-layered articles of the invention may contain one or more outer or inner layers of non-polypropylene material coated onto a preform and/or onto the article to improve the gas barrier properties of the article. The coating materials can be inorganic (e.g., silica) or organic (e.g., epoxy) in nature. Such coatings can be applied by spraying, dipping, painting, or any other means known in the art for applying a thin layer of material to a polypropylene article. Multi-layered articles of the invention can be made from multi-layered preforms, as is described in International Publication WO 00/63085.

The invention contemplates the use of a finely divided material that effectively absorbs infrared energy. Carbon black is a preferred infrared absorber. As is well known in the art, the infrared absorber can be added to the polypropylene at any time before the article is formed, e.g., during synthesis of the polypropylene polymer, in compounding the polypropylene resin or after compounding and during fabrication of the article. The infrared absorber is added to the polypropylene in the amount of about 0.1 to 500 parts per million by weight of polymer (ppm). Preferably the infrared absorber is added in the amount of about 1 to 50 ppm. Most preferably, the infrared absorber is carbon black added in the amount of about 1 to 10 ppm. When carbon black is used, it is added in small particle size, typically less than about 90 nm in diameter. Carbon black is effective with average particle sizes of 65 or 27 nm or less. Carbon black is generally available in many forms such as channel black, furnace black and slate.

The invention permits articles to be made from polypropylene with exceptional clarity. Although variation in clarity and haze can be determined visually, the degree of haze can be quantitated (in %) pursuant to ASTM D1003-97, e.g., using a Gardner XL-211 Hazemeter or from the well-known Hunter haze test. References can be established. For example, resins can be evaluated by measuring the haze on approximately 50 mil injection molded plaques. Comparing the ratio of haze to polymer thickness of the article can further evidence enhanced clarity. For example, polymer thickness can be taken as the average thickness of a panel section cut from a bottle. The haze to thickness ratios for some blow molded bottles with a side wall thickness of about 0.5 mm or less and made without addition of an infrared absorber were found to be approximately 40%/mm. Substantially lower haze to polymer thickness ratios can be obtained for comparable bottles of the invention. For example, the haze to thickness ratio for a preferred article of the invention is less than about 25%/mm or less. The haze to thickness ratio for a more preferred bottle is less than about 15%/mm or less.

The high clarity articles of the invention can comprise additional conventional additives such as nucleating agents, clarifiers, antioxidants, antistatic agents, process stabilizers, optical brighteners, coloring agents, bluing agents, and the like, which are well known in the art.

Surprisingly, it has been found that the addition of an infrared absorber enables a substantial improvement in the manufacturing productivity of the articles. The more efficient heating permitted by the infrared absorber means less time is required for heating the preforms and results in greater throughput for the ISBM process. A typical heating time for a 20 oz. (0.59 l) ISBM bottle is 60-65 seconds enabling about 600 bottles to be processed per hour (BPH). By comparison when carbon black is used, the heating time for a 20 oz. (0.59 l) bottle can be reduced to about 40 seconds enabling bottles to be processed at about 900 BPH or more.

The following examples are provided to illustrate non-limiting embodiments of the invention.

### EXAMPLES

Commercial grade polypropylene resin was used for two-stage injection stretch blow molding of bottles. The control resin (Resin A) was Acclear® 8439 polypropylene resin commercially available from BP Amoco Polymers Co. Acclear® 8439 is a 12 MFR (ASTM D1238) random copolymer of propylene and about 3.3% ethylene. Two test resins were developed from the control resin. Resin B included about 3 ppm carbon black. Resin C included about 3 ppm of carbon black and about 10 ppm of the optical brightener Leucapure EGM (7-(2H-naphtho[1,2-d]-triazol-2-yl)-3-phenyl-coumarin), available commercially from Clariant. The carbon black was commercial grade slate obtained from Degussa with an average particle diameter of about 65 nm. The carbon black and Leucapure were incorporated into the resins from a prepared concentrate using extrusion letdown steps well known in the art.

Resin pellets were injection molded into preforms (25.5 g) on an Arburg 320M molder and cooled to ambient temperature. The preforms were then stretch blow molded into 20 oz. (0.59 l) bottles suitable for use as water bottles. The preforms were reheated in an infrared oven to about 121+/−5° C. depending upon the resin and production rate. The reheated preforms were fed robotically into a Sidel SB01 ISBM unit for stretch blow molding. The preforms were stretched at about 2 m/sec.

Bottles from each of the three resins were evaluated for wall thickness, haze and production rate. A panel section was cut from the sidewall of each bottle from each resin. Thickness (mm) and haze (%) were measured at thirty points in a regular 5×6 pattern of evenly spaced rows and columns on the panel cutout. An average thickness was determined from all thirty points. Ratios of average haze to thickness for bottles from the three resins are presented in Table 1 below. Bottles from Resins B and C exhibited much less haze than bottles from Resin A. Moreover, the ratio of average haze to average thickness improved from 40 to 13.9 with the addition of carbon black to the resin and further to 11.4 with the addition of Leucapure.

TABLE 1
Summary of Haze and Thickness Data for Bottles Blow Molded
from Polypropylene Resins. Resin A contained no carbon black
and no Leucapure. Resin B contained about 3 ppm carbon black
and no Leucapure. Resin C contained about 3 ppm carbon black
and about 10 ppm Leucapure. Ave. Haze is recorded in %.
Ave. Thickness is recorded in mm.

| | Resin | | |
|---|---|---|---|
| Ave. | Resin A | Resin B | Resin C |
| Haze | 16.3 | 7.4 | 6.4 |
| Thickness | 0.406 | 0.533 | 0.559 |
| Haze/Thickness | 40.1 | 13.9 | 11.4 |

Bottles from Resin A were blow molded up to a rate of about 600 BPH. Attempts to mold bottles above this rate failed to produce acceptable bottles. Bottles were molded from Resins B and C at rates up to about 900 BPH, a 50% improvement in the processing rate for the bottles made with Resin A.

Particular embodiments having been disclosed to illustrate the invention, it is understood that the invention is not intended to be limited by the disclosed embodiments.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. A method for making a bottle comprising:
(a) heating a preform of the bottle with infrared radiation, wherein the preform is formed from a polymer consisting essentially of polypropylene, which contains an infrared absorbing agent in an amount of about 0.1 to 500 parts per million by weight of polymer; and
(b) injection stretch blow molding the preform into a bottle characterized by a ratio of haze to polymer thickness of about 25%/mm or less.

14. The method of claim 13 wherein the infrared absorbing agent is present in the amount of about 1 to 50 ppm by weight of polymer.

15. The method of claim 13 wherein the infrared absorbing agent is present in the amount of about 1 to 10 ppm by weight of polymer.

16. The method of claim 13 wherein the infrared absorbing agent is carbon black.

17. The method of claim 16 wherein the carbon black has an average particle size of less than 90 nm.

18. The method of claim 16 wherein the carbon black has an average particle size of less than 65 nm.

19. The method of claim 13 wherein the polypropylene of the bottle is characterized by a ratio of haze to polymer thickness of about 15%/mm or less.

20. The method of claim 13 wherein the preform further comprises one or more layers of a barrier material adhered to the polypropylene.

21. The method of claim 13 in which the polypropylene contains minor amounts of nucleating agents, clarifiers, antioxidants, antistatic agents, process stabilizers, optical brighteners, coloring agents, or bluing agents.

22. The method of claim 13 in which the polypropylene is a random copolymer of propylene and other alkenes, which contains about 10% or less of other alkene monomer units.

23. The method of claim 22 in which the polypropylene is a random copolymer of propylene and ethylene containing about 10% or less of ethylene monomer units.

24. A method for making a bottle comprising:
(a) heating a preform of the bottle with infrared radiation, wherein the preform is formed from a polymer consisting essentially of a random copolymer of propylene and ethylene containing 10% or less of ethylene, which contains an infrared absorbing agent in an amount of about 1 to 50 parts per million by weight of polymer; and
(b) injection stretch blow molding the preform into a bottle characterized by a ratio of haze to polymer thickness of about 25%/mm or less.

25. The method of claim 24 in which the infrared absorbing agent is carbon black.

26. The method of claim 25 wherein the carbon black has an average particle size of less than 65 nm.

27. The method of claim 24 wherein the preform further comprises one or more layers of a barrier material adhered to the polypropylene.

28. The method of claim 24 in which the polypropylene contains minor amounts of nucleating agents, clarifiers, antioxidants, antistatic agents, process stabilizers, optical brighteners, coloring agents, or bluing agents.

29. The method of claim 25 wherein the polypropylene of the bottle is characterized by a ratio of haze to polymer thickness of about 15%/mm or less.

30. The method of claim 29 wherein the bottle is an injection stretch blow molded bottle.

31. The method of claim 30 wherein the infrared absorbing agent is present in the amount of about 1 to 10 ppm by weight of polymer.

32. The method of claim 31 in which the polypropylene contains minor amounts of nucleating agents, clarifiers, antioxidants, antistatic agents, process stabilizers, optical brighteners, coloring agents, or bluing agents.
